(19) United States
(12) Patent Application Publication
(10) Pub. No.: US 2006/0195849 A1
(43) Pub. Date: Aug. 31, 2006

(54) Method for synchronizing events, particularly for processors of fault-tolerant systems

(76) Inventors: Pavel Peleska, Grafelfing (DE); Dirk Schnabel, Munich (DE)

Correspondence Address: Siemens Corporation;Intellectual Property Department, 170 Wood Avenue South, Iselin, NJ, 08830, US

(21) Appl. No.: 10/527,428

(22) PCT Filed: Aug. 6, 2003
(86) PCT No.: PCT/EP03/08715

§ 371 Date: Nov. 2, 2005

(30) Foreign Application Priority Data
Sep. 12, 2002 (EP) 02020602.5

(51) Int. Cl. G06F 9/46; G06F 9/44

(52) U.S. Cl. 719/318

(57) ABSTRACT

Identically structured processor boards operating in lockstep mode are frequently used for redundant systems. The deterministic behavior of all components comprised in the board, i.e. CPUS, chip sets, main memory, etc. is the basic condition for implementing a lockstep system, deterministic behavior meaning that said components simultaneously supply identical results if the components receive identical stimuli at the same time and if no error occurs. Deterministic behavior also requires the use of clocked interfaces. In many cases, asynchronous interfaces cause a certain temporal fuzziness in the system, preventing the overall behavior of the system from remaining synchronous. In order to nevertheless operate in lockstep mode, the invention relates to a method for synchronizing external events which are fed to and influence a component. According to said method, the external events are temporarily stored by means of buffer elements and are then retrieved in a separate mode of operating of the component so as to be processed by an execution unit of the component, said component entering into said mode of operation in response to a condition being met, which can be or is predefined and reflects the number of executed instructions.

In telecommunication systems, Data Centers and other high-availability systems in many cases as many as several hundred processor boards are used to provide the required processing power. Such a processor board typically consists of a processor or a CPU (Central Processing Unit), a chip set, main memory and peripherals.

The likelihood of a hardware defect occurring on a typical processor board within any one year is a single-digit percentage figure. Because of the large number of processor boards grouped together to form a system this means that within a given year there is a very high likelihood, unless suitable precautions are taken, of a given hardware component failing with this type of individual failure, possibly resulting in the failure of the entire system.

High system availability is demanded for telecommunication systems in particular and increasingly for Data Centers too. This figure is typically expressed as a percentage or the maximum permissible downtime per year is specified. Typical requirements are for example an availability of >99.999% or a non-availability of a few minutes per year at most. Since, in the case of a hardware defect, the exchange of a processor board and the restoration of the service usually takes some time, ranging from 10 minutes or more through to several hours, the corresponding precautions must be taken at system level for the event of a hardware defect in order to be able to meet the request for system availability.

Known solutions for meeting such high system availability requirements make provision for there to be redundant system components. The known methods can primarily be subdivided into two groups: Software-based methods and hardware-based methods

With software-based methods middleware is typically employed. The software-based solution however has been shown to be less flexible since only the (application) software which has been specifically developed for this particular redundancy scheme can be used in such a system. This considerably reduces the range of (application) software which can be used. Over and above this, the development of application software for software redundancy principles demands a very large amount of effort in practice, with the development also involving a complicated test procedure.

The basic principle underlying the hardware-based method is that of encapsulating the redundancy at hardware level so that this is transparent for the software. The major advantage of a redundancy administered by the hardware itself is that the application software is not affected by the redundancy principle and thus in most cases any given software can be used.

A principle which occurs frequently in practice for. hardware fault-tolerant systems, for which redundancy is transparent for the software, is what is referred to as the lockstep principle. Lockstep means that identically-constructed hardware, for example two boards, operates clock-synchronously in the same way. Hardware mechanisms ensure that the redundant hardware, at any given point in time, experiences identical input stimuli and must thus arrive at identical results. The results of the redundant components are compared, if they differ an error is identified and suitable measures are initiated (signaling of alarms to operating personnel, partial or complete safety shutdown, system restart).

The fundamental requirement for the implementation of a lockstep system is the deterministic timing behavior of all components contained in the board, i.e. CPUs, chip sets, main memory etc. Deterministic behavior means in this case that these components deliver identical results at identical timing points in a fault-free situation when the components receive identical stimuli at identical timing points. Deterministic timing behavior also requires the use of clock-synchronous interfaces. In many cases asynchronous interfaces cause a degree of timing imprecision in the system, which means that the overall clock-synchronous behavior of the system cannot be maintained.

For chip sets and CPUs in particular asynchronous interfaces offer technological benefits for increasing performance, in which case clock-synchronous operation in accordance with the lockstep method becomes impossible. In addition modern CPUs increasingly use mechanisms which make clock-synchronous operation impossible. These are for example internal correction measure not visible form outside, e.g. correction of an internal correctable fault on access to the cache memory which can lead to a very slight delay in instruction processing, or the speculative execution of instructions. A further example is the future increasing implementation of CPU-internal clock-free execution units which provide significant advantages in respect of speed and power dissipation but prevent clock-synchronous or deterministic working of the CPU.

One object of the present invention is thus to specify a method through which the advantages of the lockstep method are preserved and which takes account of technological development.

This object is achieved by a method for synchronization of external events in accordance with the features of Patent claim 1, a processor component in accordance with the features of the Patent claim 5 and a system in accordance with the features of Patent claim 6.

Preferred embodiments are the object of the dependent claims.

In accordance with the invention a method is provided for synchronization of external events which are routed to a CPU component and influence said component, in accordance with which the external events are buffered, with the stored external events being retrieved in a separate operating mode of the component for processing by an Execution Unit EU of the component and with the component in this operating mode responding to the fulfillment of conditions specifiable or predetermined by instructions.

In accordance with an advantageous further development the specifiable condition is implemented by the change into the separate operating mode being executed, if a comparator element K of the component establishes a match between the instruction counter CIC and a register element MIR, with the content of the register element MIR being able to be specified by instructions and the counter CIC containing the number of instructions executed by the Execution Unit since the last change to the separate operating mode.

The method is especially advantageous in conjunction with redundant systems which feature at least two CPUs and in which an identical sequence of instructions is provided for the CPUs and identical external events can be retrieved in the separate operating mode by the CPUs.

In accordance with one variant of the invention in redundant systems one faster CPU is left by a control in the separate operating mode until a slower CPU has reached the end of the separate operating mode.

Furthermore the invention provides for a CPU processor component with at least the following features:
At least one execution unit EU,
At least one counter element CIC for counting the instructions executed by the execution unit since the last change to the separate operating mode
At least one register element MIR for which the contents can be specified by instructions or is predetermined,
At least one comparator element K to switch-over the execution unit EU into a separate operating mode responding to the correspondence of the counter element CIC with the register element of MIR, with external events cached in the separate operating mode to be routed to the processor component which influence the processor component (CPU) being retrieved by the CPU component.

The retrieval of the cached external events can advantageously be undertaken here by means of software, firmware, microcode or hardware.

In accordance with the invention a system consisting of at least two CPU processor components is provided, where the CPU processor components have at least the following features:
At least one execution unit EU,
At least one counter element CIC for counting the instructions executed by the execution unit since the last change to the separate operating mode
At least one register element MIR for which the contents can be specified by instructions or is predetermined,
At least one comparator element K to switch over the Execution Unit EU into a separate operating mode responding to the correspondence of the counter element CIC with the register element of MIR, with external events cached in the separate operating mode to be routed to the processor components which influence the processor components being retrieved by the processor components.

The retrieval of the cached external events can advantageously be undertaken here by means of software, firmware, microcode or hardware.

Advantageously this system additionally features a connection between at least two of the CPU processor components, which execute an identical instruction sequence, with the connection being provided for transmission of synchronization information of the separate operating modes.

A significant advantage of the invention can be seen in the fact that the use of any new or existing software on a hardware fault-tolerant platform is made possible, in which case the processing unit supporting the invention can be used in this platform without there being the requirement for clock-synchronous, deterministic operation of the CPU and with the use of asynchronous high-speed interfaces or links being possible.

Further advantages are as follows:
The redundant boards and CPUs do not have to be coupled rigidly in phase.
The CPUs do not have to be identical, they merely have to stop after the same number of completed machine instructions and change the operating mode.
The CPUs can be operated with different clock frequencies.
The CPUs can behave differently in relation to speculative execution of instructions, since only completed instructions are evaluated.
Different CPU-internal execution and times of identical
CPUs, as a result of corrections after the occurrence of alpha particles which corrupt the data, merely lead to the synchronization events been reached at slightly different points in time.

The problems described for ensuring a clock-synchronous deterministic operation lead as a result of the timing imprecision of future CPUs to execution of instructions for which the timing cannot be precisely correlated. Since the CPU must react to external events for a typical application, e.g. to an interrupt generated by a peripheral device or to data which is written by a device into a main memory, it must be ensured that the CPU knows about these events at identical points in the instruction execution since otherwise the evaluation of these events could lead to different program execution sequences of redundant CPUs.

The present invention ensures that external events relevant to the program execution sequence, such as interrupts or data created by external devices is presented to redundant CPUs at identical points in the instruction execution and thereby the lockstep mode of operation can be emulated.

An exemplary embodiment of the invention is explained in more detail below in conjunction with one FIGURE.

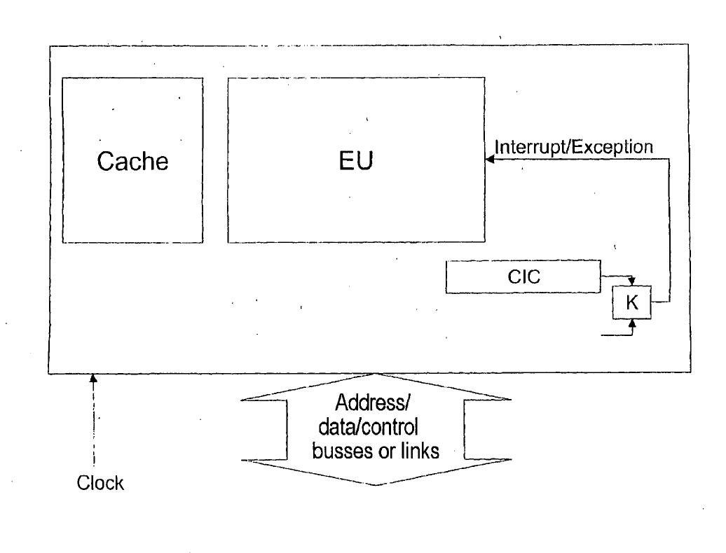

FIG. 1 shows a schematic diagram of a processor component CPU in accordance with the invention. The FIGURE only shows the components of relevance to this invention. The CPU comprises a cache memory C, one or more execution units EU, at least one comparator K, at least one instruction counter CIC for counting the instructions completed by the execution unit and at least one register element MIR, for which the contents can be specified by instructions or predetermined. Also included in the schematic are: Address bus, data bus, control bus, data connections or links and a system clock Clock.

The external events influencing the execution sequence of the program are not routed directly to the CPU but are first cached by suitably-designed hardware. This hardware can in this case be a component of a block outside the CPU or a component of the CPU itself. In accordance with the invention the CPU contains the counter CIC (Completed Instruction Counter) of the instructions or machine instructions for which the CPU has completed the execution. The CPU further contains a register MIR (Maximum Instruction Register) into which information is written by software (ELSO) supporting the emulated lockstep procedure.

Furthermore the CPU features the comparator K which compares the number of completed instructions, that is the counter CIC, with the register MIR and, if they are equal generates an interrupt request for example which interrupts instruction execution after the number of instructions specified by the register MIR and switches the CPU into another operating mode. In this operating mode for example suitable microcode is executed or a branch is made to an interrupt service routine or hardware signals are used to indicate that a synchronization point has been reached. In this operating mode the external events are then presented to the redundant CPUs so that after they leave this operating mode all CPUs can interpret these events in the same way and thus will execute the same instructions in the sequence.

For example, after reaching the number of machine instructions specified by the register MIR, the CPU branches to an Interrupt Service Routine in which the state of the interrupt signals kept away by the described hardware of the CPU is interrogated such that a redundant CPU which may make this inquiry at a slightly later point in time obtains the identical information.

Before the separate operating mode is left the counter CIC is reset. Subsequently a branch is made back to the point in the program at which the interruption occurred when the value for the counter CIC predetermined by the register MIR was reached. Thereafter the CPU will again execute the number of machine instructions predetermined by the register MIR and when counter CIC reaches the register value MIR it will change the mode and thereby make it possible to accept external events.

For example software ELSO supporting the emulated lockstep operation can set the register MIR to a value of 10,000. A CPU which is operated at a clock frequency of 5 GHz and on average executes one machine instruction per clock (length of a clock: 1/200 ps) would thus be interrupted in its instruction execution after 2 μs and enable synchronization with external events.

1.-7. (canceled)

8. method for synchronizing external events supplied to a CPU, comprising:
storing the external events;
retrieving the external events in a separate operating mode of the CPU;
processing the external event by an execution unit of the CPU; and
providing a maximum number of commands to execute prior to the CPU entering the separate operating mode.

9. The method as claimed in claim 8, wherein the maximum number of commands is predetermined.

10. The method as claimed in claim 8, wherein the maximum number of commands is specified by a command.

11. The method as claimed in claim 8, further comprising:
comparing the number of instructions executed since a change to the separate operating mode with the maximum number of commands; and
changing the CPU into the separate operating mode based on the comparison.

12. The method as claimed in claim 8, wherein the CPU remains in the separate operating mode by a controller until a second CPU has reached the separate operating mode.

13. The method as claimed in claim 12, wherein the CPU remains in the separate operating mode until the second CPU has reached an end of the separate operating mode.

14. A CPU, comprising:
an execution unit;
a completed instruction counter element for counting a number of instructions executed by the execution unit since a change to a separate operating mode;
a maximum instruction register element that can be specified by an instruction;
a comparator element that compares the maximum instruction register element with the completed instruction counter; and
a cache in the separate operating mode of an external event, the external event retrieved for processing by the CPU while in the separate operating mode.

15. The CPU as claimed in claim 14, wherein the maximum instruction register element has a predetermined value.

16. The CPU as claimed in claim 14, wherein the completed instruction counter element is reset before leaving the separate operating mode.

17. A computer system, comprising:
a first CPU;
a second CPU; and
a connection for a transmission of synchronization information of the separate operating modes between the first and second CPU,
wherein each CPU comprising:
a execution unit,
a completed instruction counter element for counting a number instructions executed by the execution unit since a change to a separate operating mode,
a maximum instruction register element having a predetermined value,
a comparator element that compares the maximum instruction register element with the completed instruction counter, and
a cache in the separate operating mode of an external event, the external event retrieved for processing by the CPU while in the separate operating mode.

18. The computer system as claimed in claim 17, wherein the maximum instruction register element is specified by an instruction.

19. The computer system in claim 17, wherein the completed instruction counter element is reset before the separate operating mode is left.

20. The computer system in claim 17, wherein the first and second CPUs have different clock frequencies.

21. The computer system in claim 17, wherein the first and second CPUs are different CPUs.
